(19) United States
(12) Patent Application Publication
(10) Pub. No.: US 2006/0050435 A1
(43) Pub. Date: Mar. 9, 2006

(54) Recording disk cartridge

(75) Inventor: Kengo Oishi, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 11/200,140

(22) Filed: Aug. 10, 2005

(30) Foreign Application Priority Data
Sep. 3, 2004 (JP) 2004-257277

(51) Int. Cl. G11B 23/03

(52) U.S. Cl. 360/133

(57) ABSTRACT

A recording disk cartridge includes: a cartridge case; a plurality of flexible recording disk media integrally rotatably housed within the cartridge case. The cartridge case includes: a lower plate for configuring a lower wall parallel to the recording disk media; an upper plate for configuring an upper wall parallel to the recording disk media; an opening at a side plane defined by the lower and upper plates; a lower rotor being arranged inside with facing the lower plate; an upper rotor being arranged inside with facing the upper plate; a shutter linking the lower rotor with the upper rotor. The lower and upper rotors include at peripheral thereof arched protrusions, respectively, and the lower plate and the upper plate include at peripheral thereof arched grooves, respectively, to provide rotational support of the lower and upper rotors by the lower and upper plates, respectively, with a rotational axis.

### BACKGROUND OF THE INVENTION

1. Field of the Invention

The present invention relates to a recording disk cartridge comprising a plurality of flexible recording disk media.

2. Description of the Related Art

Conventionally, as a recording disk medium a flexible recording disk medium is known where a magnetic layer is formed on both faces of a disk-form support body consisting of a flexible material such as a polyester sheet. Although the magnetic disk medium has a merit of speedily accessing data in comparison with a magnetic tape, it has a demerit of a low memory capacity because a recording area thereof is small.

In order to solve the demerit of the flexible magnetic disk medium, is disclosed a magnetic disk cartridge for housing a plurality of magnetic disk media in a single cartridge case (see JP 2004-22011A).

In this connection, because a flexible magnetic disk medium is low in rigidity thereof, there is a problem that the medium tends to vibrate in a direction vertical to a recording face when rotated. Therefore, in JP 2004-22011A each magnetic disk medium has a configuration of being pinched by shutters. Thus by arranging plate members of high rigidity such as the shutters in a vicinity of the magnetic disk medium, the recording face can be stabilized because the medium moves along the plate members, as the medium rotates.

However, because a magnetic disk cartridge disclosed in JP 2004-22011A is configured of movable shutters arranged by four for one magnetic disk medium, there is a problem that the cartridge is complicated in a structure thereof and is difficult to keep a parallelism to the medium. In addition, because the magnetic disk cartridge is a mass produced good, it is preferable to be excellent in assembling and productivity. Furthermore, the magnetic disk cartridge is preferable to flexible in a design change so as to easily set a plurality of kinds thereof where number of magnetic disk media is made three, five, and the like.

Further, because the magnetic disk cartridge is a product of which reliability is required to be high, stable operation is required in the shutter mechanism for opening and closing the opening for the head for a long period.

### SUMMARY OF THE INVENTION

Preferably, is provided a recording disk cartridge having a simple structure and being excellent in assembling, productivity, easiness in changing the number of recording disk media, and shutter opening and closing operation.

A first aspect of the present invention provides a recording disk cartridge comprising: a cartridge case; a plurality of flexible recording disk media integrally rotatably housed within the cartridge case, the cartridge case comprising: a lower plate for configuring a lower wall parallel to said plurality of the recording disk media; an upper plate for configuring an upper wall parallel to said plurality of the recording disk media; a side wall extending between peripheries of the lower plate and the upper plate and comprising an opening; a lower rotor arranged inside and facing the lower plate; an upper rotor arranged inside and facing the upper plate; and a shutter for closing and opening the opening and providing a linkage between the lower rotor and the upper rotor, wherein the lower rotor and the upper rotor comprise, at the peripheries thereof, arched protrusions with a rotation axis on surfaces thereof facing the lower rotor and the upper rotor, respectively, and the lower plate and the upper plate comprise at peripheries thereof arched grooves with the rotation axis for slidingly fitting in the protrusions, respectively, so as to provide rotational support of the lower rotor and the upper rotor by the lower plate and the upper plate, respectively, with the rotational axis.

According to the structure, the recording disk cartridge may be configured by stacking, for example, the lower plate and the upper plate. Further, when magnetic heads provided in a recording and reproducing apparatus access the recording disk cartridge through an opening of the recording disk cartridge, in the recording disk cartridge, the lower rotor and the upper rotor may integrally rotate with the shutter. In that event, the protrusions formed on the lower and upper rotors may be guided by the arched support grooves of the lower plate and the upper plate to smoothly revolve the shutter having a curvature corresponding to peripheries of the lower and upper rotors.

A second aspect of the present invention based on the first aspect provides the recording disk cartridge further comprising an engage portion engageable with external actuation for operating the shutter to close and open the opening.

The engage portion may be provided by gears or friction engagement.

A third aspect of the present invention based on the first aspect provides the recording disk cartridge further comprising at least one inner plate between the lower rotor and the upper rotor and stacked between the upper plate and the lower plate for partitioning a plurality of the recording disk media.

According to this structure, the recording disk cartridge may be configured by stacking, for example, the lower plate, the inner plates, and the upper plate. Accordingly, an inner plate and a recording disk medium can be handled as a unit, and thus, the number of the disk media can be increased by increasing the number of the units, wherein each unit may have the same structure, which provides a high productivity. Further, during assembling, the recording disk media can be conveyed by handling the lower plate or the inner plate without damage or stain, so that assembling property can be improved. The inner plate for partitioning may be fixed as a portion of recording disk cartridge at the rim thereof, so that accuracy in parallelism can be easily provided, which improves stability in rotation of the recording disk media.

A fourth aspect of the present invention based on the first aspect provides the recording disk cartridge, wherein height of the protrusions is greater than a depth of the grooves and smaller than a distance between bottoms of the grooves of the lower plate and the upper plate.

According to this structure, the lower rotor and the upper rotor may slide on the upper and lower plates only between tips of the lower rotor and the upper rotor and the grooves of the lower rotor and the upper rotor, smoothing the rotation of the lower rotor and the upper rotor and the operation of the shutter.

A fifth aspect of the present invention based on the first aspect provides the recording disk cartridge further comprising a friction reduced portion on at least one of a side of the protrusions and a side of the grooves.

A sixth aspect of the present invention based on the fifth aspect provides the recording disk cartridge, wherein the friction reduced portion comprises a surface area reduced portion.

A seventh aspect of the present invention based on the fifth aspect provides the recording disk cartridge, wherein the friction reduced portion comprises a surface area reduced portion.

An eighth aspect of the present invention based on the fifth aspect provides the recording disk cartridge, wherein the friction reduced portion comprises a lubricant layer.

A ninth aspect of the present invention based on the fifth aspect provides the recording disk cartridge, wherein the friction reduced portion comprises an oleoresin layer.

A tenth aspect of the present invention based on the fifth aspect provides the recording disk cartridge further comprising a wear reduced portion on at least one of a side of the protrusions and a side of the grooves.

An eleventh aspect of the present invention based on the first aspect provides the recording disk cartridge, wherein the recording disk media comprise magnetic disk media.

A twelfth aspect of the present invention provides a recording disk cartridge comprising: a cartridge case; a plurality of flexible recording disk media integrally rotatably housed with a rotation axis within the cartridge case, the cartridge case comprising: a lower plate for configuring a lower wall parallel to said plurality of the recording disk media; an upper plate for configuring an upper wall parallel to said plurality of the recording disk media; a side wall extending between peripheries of the lower plate and the upper plate and comprising an opening; a lower rotor arranged inside and facing the lower plate; an upper rotor arranged inside and facing the upper plate; and a shutter for closing and opening the opening and providing a linkage between the lower rotor and the upper rotor, wherein the lower rotor and the lower plate comprise, at the peripheries thereof, an arched lower protrusion with the rotation axis and an arched lower groove with the rotation axis for slidingly fitting in the lower protrusion, and the upper rotor and the upper plate comprise, at the peripheries thereof, an arched upper protrusion with the rotation axis and an arched upper groove with the rotation axis for slidingly fitting in the upper protrusion, so as to provide rotational support of the lower rotor and the upper rotor by the lower plate and the upper plate, respectively, with the rotational axis.

### BRIEF DESCRIPTION OF THE DRAWINGS

The object and features of the present invention will become more readily apparent from the following detailed description taken in conjunction with the accompanying drawings in which:

FIG. 1 is an exploded perspective view of a magnetic disk cartridge according to an embodiment of the present invention;

FIG. 2A is a perspective view of a magnetic disk cartridge with a shutter closed according to the embodiment of the present invention;

FIG. 2B is a perspective view, with the shutter opened, of the magnetic disk cartridge according to the embodiment of the present invention;

FIG. 3 is a perspective view showing an inner face of an upper plate according to the embodiment of the present invention;

FIG. 4 is a section view taken along a line IV-IV in FIG. 2B of the magnetic disk cartridge loaded on a magnetic disk drive according to the embodiment of the present invention;

FIG. 5 is a partially enlarged sectional view of FIG. 4;

FIG. 6 is an exploded perspective view showing a stack structure of magnetic disk media according to the embodiment of the present invention;

FIG. 7 is a partially enlarged perspective view illustrating connecting condition among lower and upper rotors and an upper plate according to the embodiment of the present invention;

FIG. 8 is a partially enlarged perspective view illustrating connecting condition among lower and the upper rotors and an upper plate without gap of a proto-type magnetic disk cartridge according to the present invention; and

FIGS. 9 to 13 are enlarged sectional views of the rims of the lower and upper rotors and the groove of the lower and upper plate according to the embodiment of the present invention.

The same or corresponding elements or parts are designated with like references throughout the drawings.

### DETAILED DESCRIPTION OF THE INVENTION

Here will be described an embodiment of the present invention in detail, referring to drawings as needed. In the embodiment will be described a case of adopting a magnetic disk medium as an example of a recording disk medium.

Meanwhile, in a description below, with respect to up/down directions, making it a standard a typical use state of the magnetic disk cartridge, vertical directions for faces of magnetic disk media are called the up/down directions for convenience.

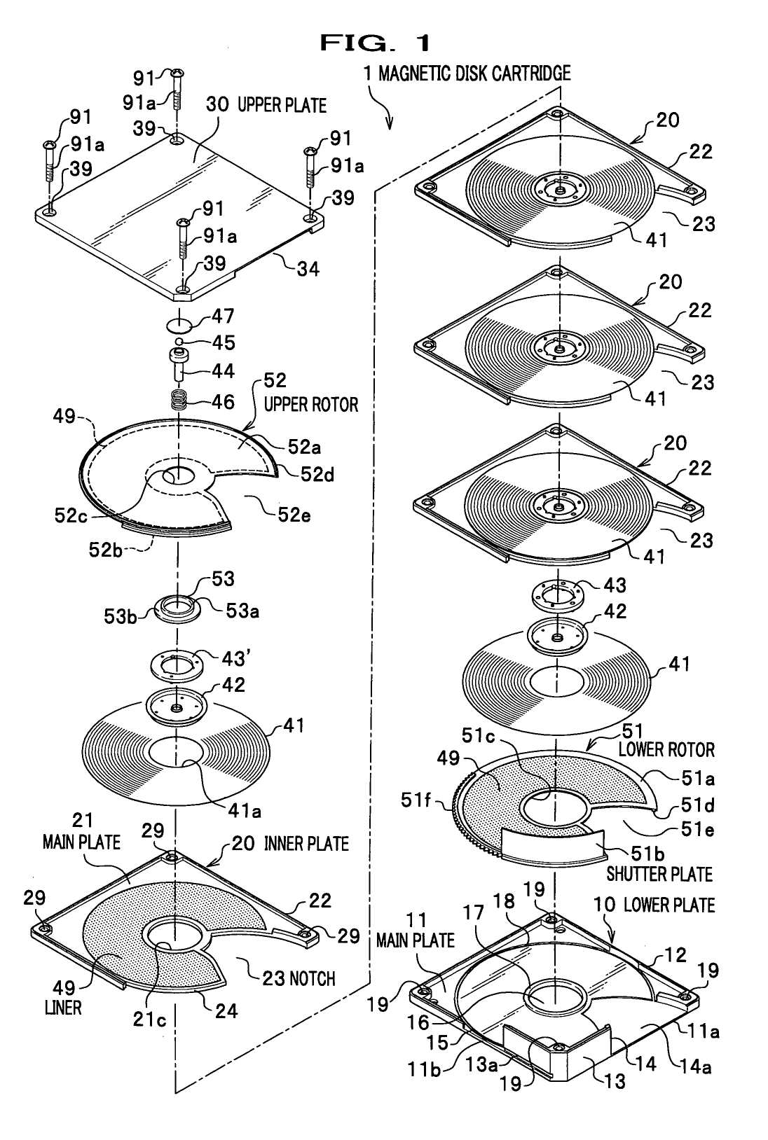

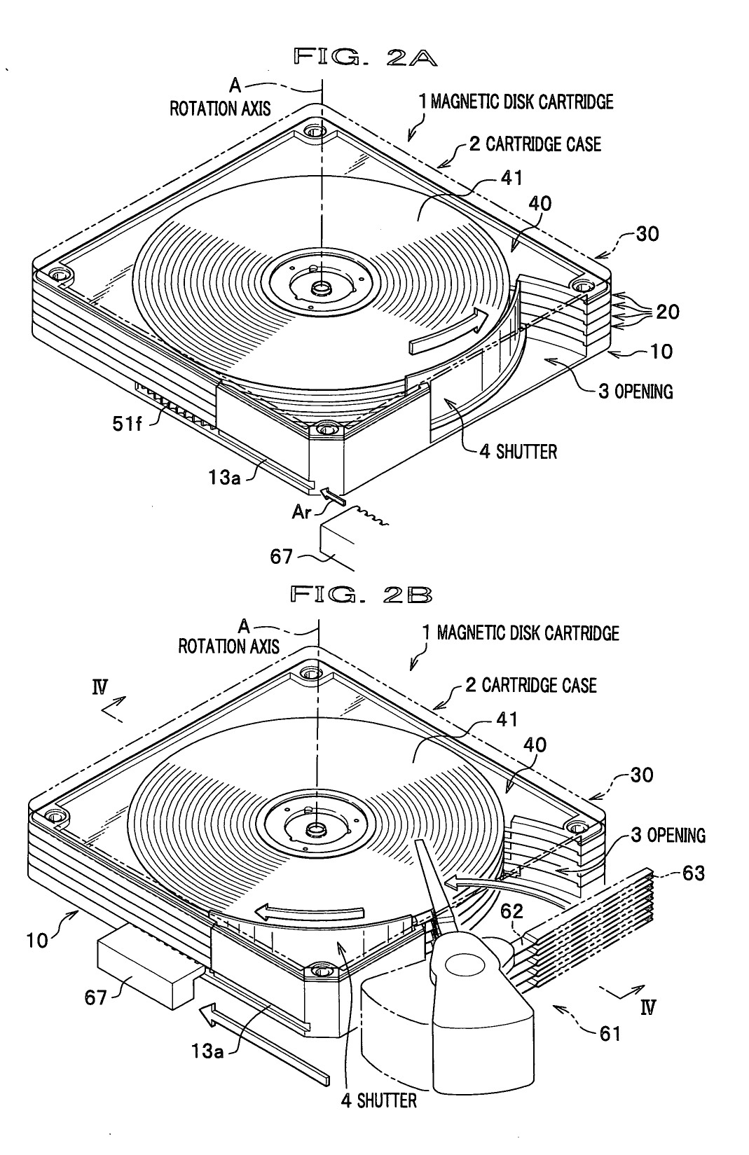

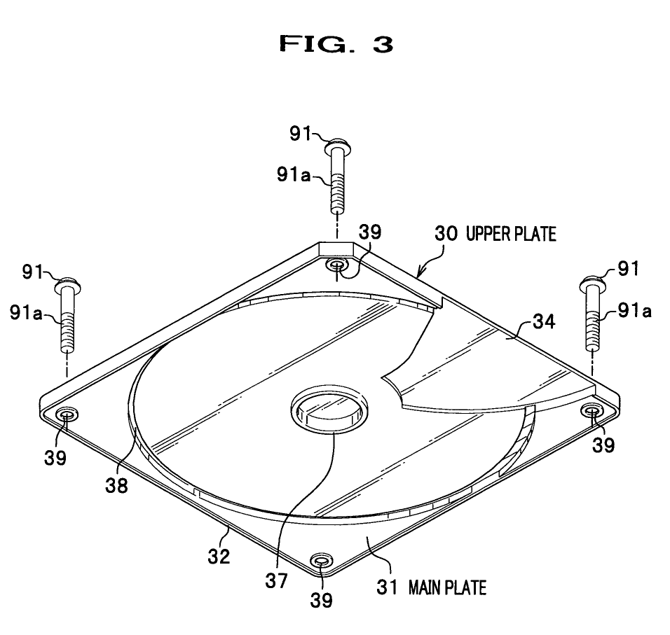

As shown in FIG. 1, in a magnetic disk cartridge 1 of an example of a recording disk cartridge are stacked a lower plate 10 for configuring a lower wall thereof; a plurality of, for example, four inner plates 20, and an upper plate 30 for configuring an upper wall thereof in this order; these are fastened and fixed with four screws 91; and thereby a cartridge case 2 (see FIG. 2A) is configured. Between the lower plate 10 and the lowermost inner plate 20, between any adjacent two of the four inner plates 20, and between the uppermost inner plate 20 and the upper plate 30 are arranged magnetic disk medium 41, respectively. Each magnetic disk medium 41 is a disk form having an opening 41a at the center thereof, and a center core 42 made of metal is affixed at rim of the opening 41a (an inner edge of the magnetic disk medium 41). It is designed that any adjacent two center cores 42 are engaged by spacers 43, 43′, and that five magnetic disk media 41 are integrally rotated. The magnetic disk media 41 stacked and integrated are referred to as a disk stack 40.

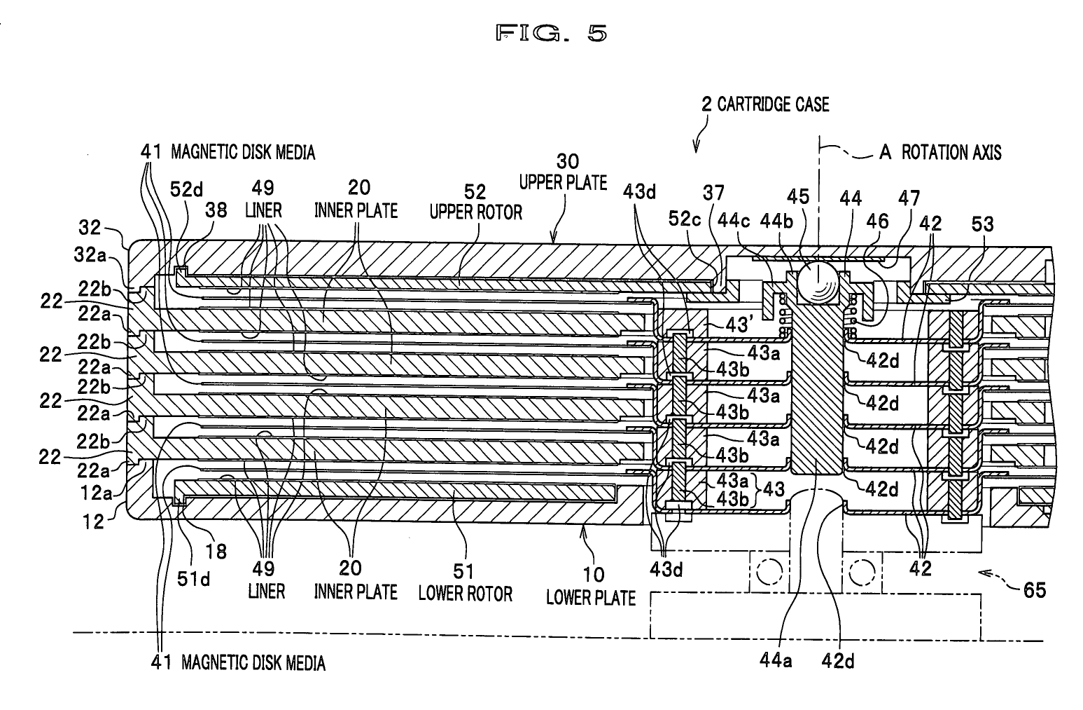

In each of the inner plates 20 is formed a rib 22 for contact with upper/lower plates at a peripheral rim of a flat main plate 21 to define the vertical position thereof and the vertical positions of the upper/lower plates. Part of a right near side (in FIG. 1) of each of the inner plates 20 forms a notch 23 so that magnetic heads 63 (see FIG. 4) can easily move onto the magnetic disk media 41. At the portion of the notch 23 is not formed the rib 22, and therefore, when the inner plates 20 are stacked up, an opening 3 is formed on a side face of the cartridge case 2 as shown in FIG. 2A.

The opening 3 is opened/closed by a shutter 4 that coaxially revolves with the disk stack 40. As shown in FIG. 1, the shutter 4 is configured by combining a lower rotor 51 and an upper rotor 52 using a shutter plate 51b.

Next will be described each member in more detail.

The lower plate 10 is designed at a peripheral rim of a main plate 11 of a substantially square to mainly form a rib 12 for abutting on a lower face of the rib 22 of the lowermost inner plate 20 and a side wall 13. On the upper surface of the lower plate 10 is rotatably arranged a lower rotor 51. The side wall 13 is vertically provided in a predetermined range, for example, around one third range of one edge, from one corner of the main plate 11 (near side corner in FIG. 1), and is formed approximately in height of the inner plates 20 stacked.

A sector portion toward a center of the main plate 11 from one edge 11a (one edge of right near side in FIG. 1) continuing into the side wall 13 of the main plate 11 is designed to form a depression 14a lowered by one step, not to form the rib 12 at the peripheral rim of the main plate 11, and to become an opening 14 (a part of the opening 3). Thus it becomes easy for the magnetic heads 63 to proceed into the cartridge case 2.

An approximately central one third range of the other edge 11b (one edge of left near side in FIG. 1) continuing into the side wall 13 of the main plate 11 is designed not to form the rib 12 but to provide an opening 15 so that a gear 51f (engaging portion) of the lower rotor 51 described later can be exposed. In addition, outside the side wall 13 of the other edge 11b is formed a groove 13a along a periphery of the lower plate 10, continuing into the opening 15. The groove 13a is designed to be a passage where a shutter open gear 67 (see FIG. 2A) of a magnetic disk drive proceeds in a direction shown in an arrow AR in FIG. 2A and enters in the opening 15 in order to engage in the gear 51f.

The rib 12 is formed so as to protrude upward across the whole periphery except the side wall 13 and the openings 14, 15 out of a peripheral rim of the main plate 11. At the center of the main plate 11 is formed a circular opening 16 for exposing the center core 42 provided inside the lowermost magnetic disk medium 41. At upper rim of the opening 16, across the whole periphery thereof is formed a rib 17 (an annular rib) outside which a central opening 51c formed at the center of the lower rotor 51 fits. The rib 17 rotationally freely supports the lower rotor 51.

In addition, on an upper face (inner face) of the main plate 11 is formed, at a position corresponding to a peripheral portion of the lower rotor 51, a circular lower rotor support groove (supporting groove) 18 into which a rib (protrusion) 51d is slidingly inserted. The lower rotor support groove 18 rotationally freely supports the lower rotor 51 coaxially with the magnetic disk media 41 by engaging in a rib 51d (see FIG. 4) formed downward at a peripheral rim of the lower rotor 51.

In addition, at four corners of the main plate 11 are formed screw holes 19 where female threads are formed, respectively, with penetrating through the up/down directions.

The main plate 21 of each of the inner plates 20 is substantially a square, and a portion corresponding to one of four corners of the square is designed to be an arc (arc portion 24) one size larger than the magnetic disk medium 41. At one edge (right near side in FIG. 1) continuing into the arc portion 24 is formed the notch 23 into a sector. The rib 22 protrudes the up/down directions and is formed across all periphery except the arc portion 24 and the notch 23 out of periphery rim of the main plate 21. At center of the main plate 21 is formed a central opening 21c for enabling the upper center core 42 to be exposed and to be coupled with the lower center core 42.

In addition, at three corners of the main plate 21, with penetrating through the three corners in the up/down directions, are formed holes 29 through which screw shaft portions 91a of the screws 91 are inserted, respectively.

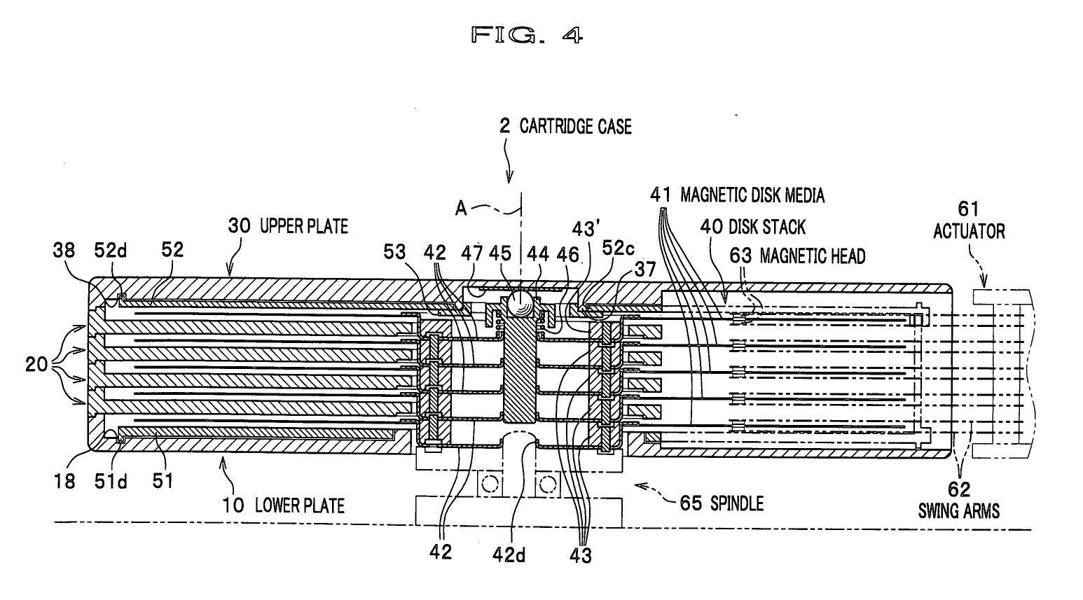

The upper plate 30 is formed substantially symmetric to the lower plate 10. On a lower surface of the upper plate 30 is rotatably arranged the upper rotor 35. As shown in FIG. 3, in the upper plate 30, on a substantially square main plate 31 are formed a depression 34 corresponding to the depression 14a, a rib (annular rib) 37 corresponding to the rib 17 and rotatably supporting a central opening 52c, and an arc upper rotor support groove 38 (supporting groove) corresponding to the lower rotor support groove 18, into which a rib (protrusion) 52d is inverted. Meanwhile, at the center of the main plate 31 are not formed an opening and a side wall corresponding to the side wall 13.

In addition, at a peripheral rim of the main plate 31, across all periphery except the depression 34 is formed a rib 32 protruding downward.

In addition, at four corners of the main plate 31 are respectively formed holes 39 that enable the screw shaft portions 91a of the screws 91 to be penetrated therethrough.

The lower rotor 51 is designed so that: a central opening 51c, a notch 51e, the rib 51d, and the gear (engage portion) 51f are formed on a ring-form lower rotor plate 51a substantially same as the magnetic disk media 41; and the shutter plate 51b is vertically provided at the peripheral rim of the lower rotor plate 51a. The central opening 51c is formed as a circle fitting outside the rib (annular rib) 17, the notch 51e is formed as a sector corresponding to the depression 14a. In addition, the rib (protrusion) 51d is arched and provided downward at a peripheral rim of a lower face of the lower rotor plate 51a around a rotation axis A, corresponding to the lower rotor support groove 18.

The shutter plate 51b is a blocking member for blocking the opening 3 (see FIG. 2A) and the disk stack 40 and is vertically provided along the peripheral rim of the lower rotor plate 51a with neighboring the notch 51e. The gear 51f is an engaged portion for opening/closing the shutter 4 (see FIG. 2A) from outside of the magnetic disk cartridge 1, and is formed at a peripheral rim of the lower rotor plate 51a within a predetermined range with neighboring the shutter plate 51b.

The upper rotor 52 is designed to be substantially symmetrical to the lower rotor 51:.the upper rotor 52 comprises an upper rotor plate 52a similar to the lower rotor plate 51a; on the upper rotor plate 52a are formed a central opening 52c fitting outside the rib 37 of the upper plate 30, a notch 52e corresponding to the depression 34, and an arched rib (protrusion) 52d corresponding to the upper rotor support groove 38 and provided around the rotation axis A on the surface facing the upper plate 30. In addition, at a portion adjacent to the notch 52e of a peripheral rim of the upper rotor plate 52a is formed a shutter groove 52b, corresponding to the shutter plate 51b of the lower rotor 51. The lower rotor 51 and the upper rotor 52 are designed to integrally rotate by engagement of the shutter groove 52b with an upper end rim of the shutter plate 51b.

The upper rotor 52 is rotationally freely supported by the upper plate 30 by the central opening 52c fitting outside the rib (annular rib) 37 of the upper plate 30, and the rib 52d engaging in the upper rotor support groove 38. In addition, the upper rotor 52 is prevented from dropping from the upper plate 30 by support of a stop member 53 fitting to the rib 37. The stop member 53 comprises a cylindrical portion 53a inserted in the rib 37 (see FIG. 3) and a flange 53b formed at one end of the cylindrical portion 53a; the cylindrical portion 53a is inserted in the central opening 52c from a lower side of the upper rotor 52 and is fixed at the rib 37 by, for example, ultrasonic welding, adhesion.

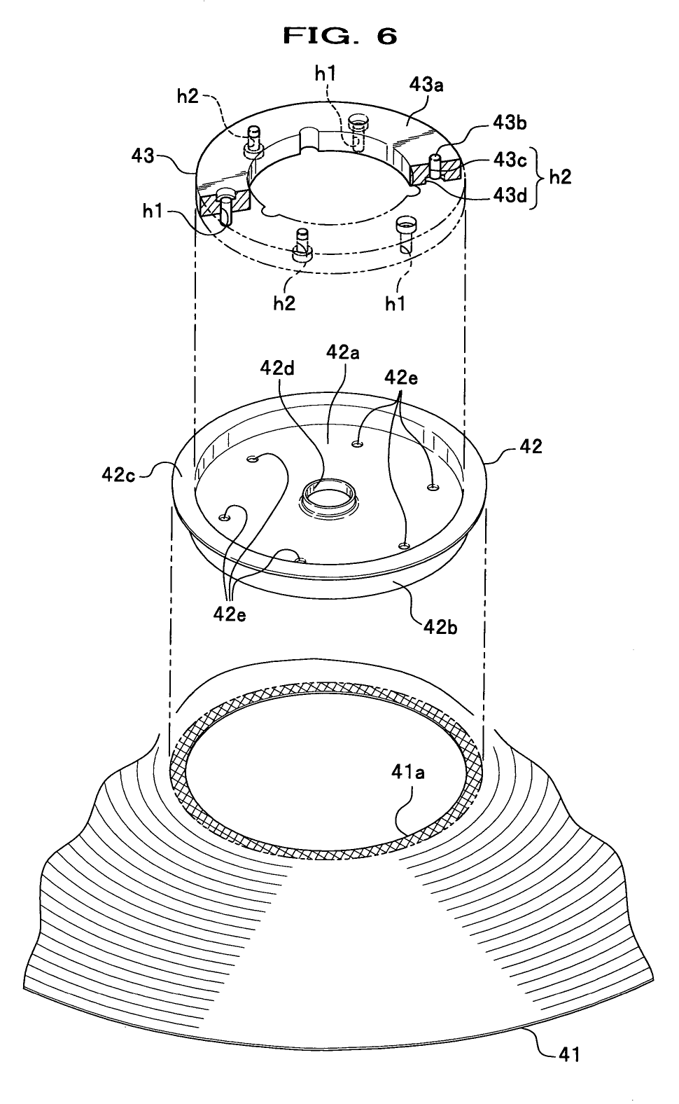

As an enlarged section drawing is shown in FIG. 5, an upper face of the lower rotor 51, upper and lower faces of the inner plates 20, and a lower face of the upper rotor 52 are faces opposing the magnetic disk media 41, where liners 49 are affixed across portions opposing the media 41, respectively.

The liners 49 comprise, for example, a non-woven cloth such as a polyester fiber and a blended fabric fiber of rayon and polyester.

Next will be described a stack structure of the lower plate 10, the inner plates 20, and the upper plate 30.

In the rib 12 of the lower plate 10, as shown in FIG. 5, an inside thereof is formed higher by one step than an outside thereof, and thereby a male type step portion 12a is formed; each rib 22 of the inner plates 20 forms a female type step portion 22a protruding downward at outermost periphery, and thus a periphery of the male type step portion 12a and an inner perimeter of the female type step portion 22a become able to be fitted. In addition, when the lower plate 10, the inner plates 20, and the upper plate 30 are fastened by the screws 91 (see FIG. 1), an upper face of the male type step portion 12a and a corresponding portion of a lower face of the lowermost inner plate 20 are designed to be contacted. Thus, because the rib 12 of the lower plate 10 and the rib 22 of the inner plate 20 are sealingly abutted and fitted (sliding-fitted) each other, an invasion of dust into the cartridge case 2 from outside is prevented.

Similarly, any adjacent two of the inner plates 20, and the uppermost inner plate 20 and the upper plate 30 are stacked by being sealingly abutted and fitted (sliding-fitted) each other. In other words, on an upper face of each of the inner plates 20 is formed a male type step portion 22b where an inside of the upper face is formed higher by one step; at a rib 32 of the upper plate 30 is formed a female type step portion 32a of which outermost periphery protrudes downward by one step. And the male type step portion 22b of one inner plate 20 and the female type step portion 22a of an upper adjacent inner plate 20 are sealingly abutted and fitted (sliding-fitted) each other; the male type step portion 22b of the uppermost inner plate 20 and the female type step portion 32a of the upper plate 30 are sealingly abutted and fitted (sliding-fitted), and stacked. Thus any adjacent two of the ribs 12, 22, and 32 are sealingly abutted and fitted (sliding-fitted) each other, and dust from outside is prevented from invading into the cartridge case 2. In addition, as soon as the lower plate 10, the inner plates 20, and the upper plate 30 are stacked, the side wall 13 of the cartridge case 2 is configured. Furthermore, because the lower plate 10, the inner plates 20, and the upper plate 30 are accurately positioned each other, and respective relative movements go away by being sealingly abutted and fitted (sliding-fitted) each other, a rigidity of the cartridge case 2 improves.

In addition, both of the female type step portion 22a and the male type step portion 22b protrude from the main plate 21 beyond a thickness of the liner 49. Therefore, after affixing the liners 49 on the inner plates 20 and making an assembly, then even if placing it on a work bench, the liners 49 are not in contact with the work bench, and accordingly, are not contaminated with dust and the like.

Such configuration of the cartridge case 2 by stacking the inner plates 20 facilitates a change of the number of the magnetic disk media 41; although a height change of the side wall 13 and that of the shutter plate 51b are requested, the number of housing units of the magnetic disk media 41 formed within the cartridge case 2 can be changed simply by mainly changing the number of the inner plates 20.

Next will be described the magnetic disk media 41 and a stack structure thereof. The magnetic disk media 41 are ones where magnetic paint is coated on both faces of a resin sheet, for example, such as polyester.

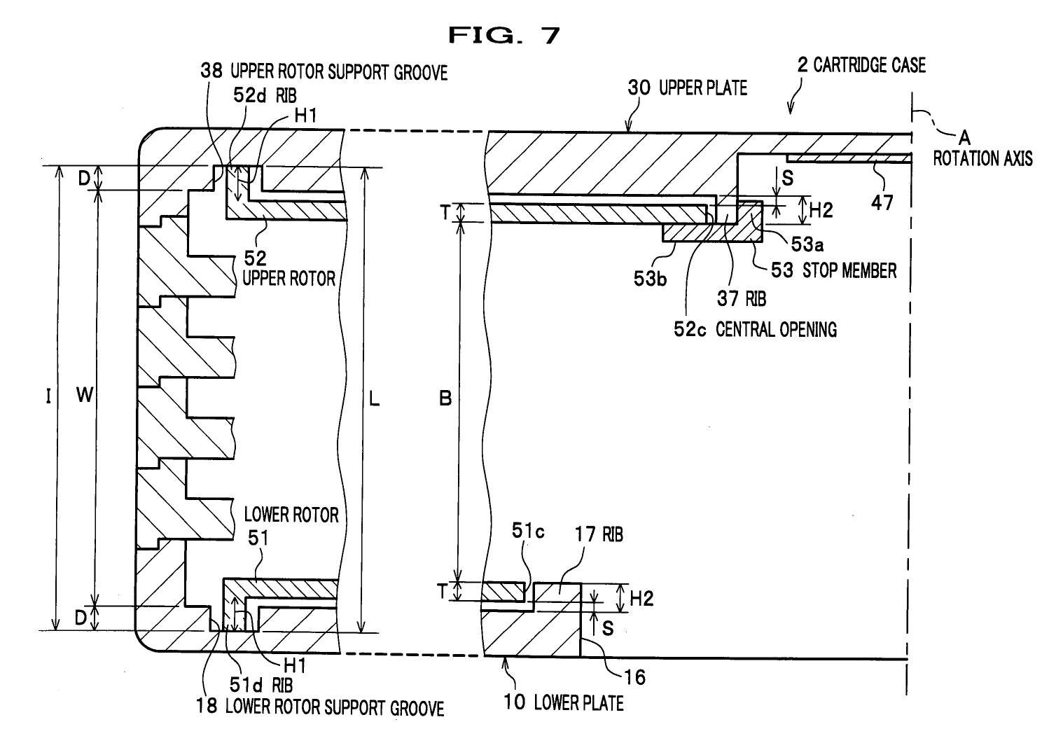

As shown in FIG. 6, each of the center cores 42 is one substantially made a hat form with draw forming a metal plate by press: the center core 42 is mainly configured of a circular bottom plate 42a, a low cylindrical side wall 42b rising from peripheral rim of the bottom plate 42a, and a flange 42c widening in an outer diameter direction from an upper end of the side wall 42b. At center of the bottom plate 42a is formed a center hole 42d, and at rim of the plate 42a are formed six small holes 42e at a distance of 60 degrees, making the center hole 42d a center thereof.

A spacer 43 is provided between adjacent center cores 42, keeps a distance of each of the center cores 42, stops a rotation between each of the center cores 42, and functions so that the stacked magnetic disk media 41 integrally rotate. The spacer 43 is mainly configured of a main body portion 43a shaped like a ring from a resin and metallic pins 43b pressed into the main body portion 43a. In the main body portion 43a are formed six penetration holes h1 and h2 at positions corresponding to the small holes 42e of the center core 42, wherein each of the penetration holes h1 and h2 consists of a small diameter hole portion 43c, where the pin 43b is pressed, and a large diameter hole portion 43d that is coaxial with and slightly larger in diameter than the small diameter hole portion 43c. The six penetration holes h1 and h2 are designed to be upside down in any two adjacent ones. In other words, penetration holes h2 of both adjacent penetration holes h1, where each the large diameter hole portion 43d is positioned at an upper side thereof, are arranged so that the large diameter hole portion 43d is positioned at a lower side thereof.

Into each of the small diameter portions 43c is pressed each one pin 43b from upper/lower sides thereof, one end of the pin 43b is positioned at a boundary of the large diameter hole portion 43d and the small diameter hole portion 43c, and the other end thereof protrudes outside the small diameter portion 43c. The large diameter hole portion 43d serves as a clearance at ends of pins 43b of adjacent spacers 43.

As shown in FIG. 5, such the spacers 43 are provided between adjacent center cores 42, respectively. One pin 43b protruding toward a lower side of each of the spacers 43 enters in a small hole 42e of one center core 42 at the lower side of the spacer 43, and stops a rotation relative to the center core 42 at the lower side. If there is another spacer 43 at a still lower side than the center core 42 at the lower side, a floating-up of the spacer 43 for the center core 42 is prevented by the pin 43b entering the large diameter hole portion 43d in the spacer 43 at the lower side. The other pin 43b protruding toward an upper side of the spacer 43 enters in a small hole 42e of the other center core 42 at the upper side of the spacer 43, and stops a rotation relative to the center core 42 at the upper side. If there is another spacer 43 at a still upper side than the center core 42 at the upper side, the top end of the pin 43b enters in the large diameter hole portion 43d in the spacer 43 at the upper side.

Meanwhile, because at an upper side the uppermost center core 42 has no center core 42 to stop a rotation thereof, at the upper side is arranged a thin top spacer 43′ in thickness where the pin 43b is protruded only downward.

The magnetic disk media 41 thus stacked, namely, the disk stack 40, are stably supported in rotation by a coupling shaft 44, a bearing ball 45, a compression coil spring 46, and a center plate 47.

As shown in FIG. 5, the coupling shaft 44 lessens a central fluctuation between the center cores 42 stacked, holds the bearing ball 45 and the compression coil spring 46, and comprises a shaft portion 44a, a ball holding portion 44b, and a spring holding portion 44c. The shaft portion 44a is a columnar form that can be inserted through the center holes 42d of the center cores 42. At an upper end of the shaft portion 44a the ball holding portion 44b is formed into a cylindrical form with a bottom opening to an upper side thereof. A depth of the ball holding portion 44b is larger than a radius of the bearing ball 45, and therefore, the bearing ball 45 is stably held at the ball holding portion 44b. The spring holding portion 44c consists of a form where a cylindrical form with a bottom is turned down at a side of an outer diameter of the ball holding portion 44b, and the compression coil spring 46 is arranged in a cylindrical space between the shaft portion 44a and the spring holding portion 44c. Meanwhile, although a length of the coupling shaft 44 is arbitrary, in the embodiment it is one reaching the second center core 42 from the lowermost one; the center hole 42d of the lowermost center core 42 is opened so that a spindle 65 of a magnetic disk drive can proceed.

The center plate 47 is a slide member affixed at the center of an inner face of the upper plate 30, that is, on a flat face of an inside of the rib 37. The center plate 47 can be composed of, for example, a material excellent in sliding ability and abrasion resistance such as polyoxymethylene and ultra high molecular weight polyethylene.

Although the bearing ball 45 consists of a sphere made of, for example, steel used for a ball bearing, it may also be composed of a material excellent in sliding ability and abrasion resistance, for example, such as polytetrafluoroethylene and polyoxymethylene. The bearing ball 45 is arranged within the ball holding portion 44b of the coupling shaft 44, abuts on the bottom face of the ball holding portion 44b; and a center of an inner face of the upper plate 30, that is, the center plate 47 by a point contact, and rotationally supports the disk stack 40.

In the compression coil spring 46 one end (upper end) is held by the spring holding portion 44c of the coupling shaft 44; the other end (lower end) abuts on an upper face of the uppermost center core 42, and energizes the stacked center cores 42 to the side of the lower plate 10, that is, to the side of the spindle 65 of the magnetic disk drive. Thus the center cores 42 do not jounce within the cartridge case 2, and the fluctuation of the magnetic disk media 41 is prevented in rotation thereof.

A magnetic disk drive for recoding/reproducing data for the magnetic disk cartridge 1 rotates, as shown in FIG. 4, the disk stack 40 by the spindle 65. The spindle 65 attracts the lowermost center core 42 by magnetic force, enters in the center hole 42d of the center core 42, and thereby matches an axis thereof with that of the disk stack 40. At this time, because the spindle 65 slightly lifts up the center cores 42 with resisting an energizing force of the compression coil spring 46, as shown in FIGS. 4 and 5, each of the magnetic disk media 41 is positioned at center of a space formed between the lower rotor 51 and the lowermost inner plate 20, between upper and lower inner plates 20, and between the uppermost inner plate 20 and the upper rotor 52. The magnetic heads 63 are provided at top ends of swing arms 62. Each of the magnetic heads 63 is arranged on both faces of each of the magnetic disk media 41.

The magnetic disk cartridge 1 thus described can prevent, in no use thereof as shown in FIG. 2A, an invasion of dust thereto by closing the opening 3 with rotating the shutter 4 in a counterclockwise direction of the drawing; in use thereof as shown in FIG. 2B, when loaded on the magnetic disk drive, the shutter open gear 67 fits in the groove 13a, is guided thereby, engages in the gear 51f, and rotates the shutter 4 in a clockwise direction of the drawing.

In addition, the disk stack 40 rotates by the spindle 65 rotating. After then, the swing arms 62 rotate by being driven with an actuator 61, and each of the magnetic heads 63 are moved onto each face of the magnetic disk media 41.

When recording data on the magnetic disk media 41 with the magnetic heads 63, the data is recorded thereon by sending a signal to the magnetic heads 63 by a control circuit not shown; when reproducing data from the magnetic disk medium 41, a signal is output by detecting a change of a magnetic field on the medium 41 with the magnetic heads 63a.

At this time, dust on the magnetic disk media 41 is removed by the liners 49 appropriately touching respective media 41.

After the use of the magnetic disk cartridge 1, the magnetic heads 63 are retracted from the cartridge case 2, thereafter ejects the magnetic disk cartridge 1; thereby the gear 51f is driven by the shutter open gear 67, and the shutter 4 closes the opening 3.

Thus because the magnetic disk cartridge 1 has a plurality of the magnetic disk media 41, data transfer can be performed at a higher speed by simultaneously accessing data with a plurality of magnetic heads 63.

In addition, because the cartridge case 2 is configured by stacking up the inner plates 20, it is easy to perform a specification change of making the number of magnetic disk media 41 a different one. Then, in assembling the magnetic disk cartridge 1, the magnetic disk media 41 can be handled with being placed on the inner plates 20 and the lower rotor 51 built in the lower plate 10. This can reduce a possibility of touching the magnetic disk media 41 and thus further stabilize quality of the cartridge 1.

In addition, because each of the inner plates 20 is stacked on the lower plate 10 or another inner plate 20 and is fixed, the magnetic disk cartridge 1 can make higher a parallelism to the magnetic disk media 41, can stabilize a rotation of the media 41, and enable a higher speed rotation of the media 41, furthermore a higher speed of a data transfer.

Will be described relations between the lower plate 10 and the upper plate 30 and between the lower rotor 51 and the upper rotor 52 with respect to dimension and axial supporting structure.

In the disk cartridge 1, when the magnetic heads 63 for recording and reproducing provided in a recording and reproducing apparatus access the magnetic disk cartridge 1 as shown in FIG. 2B, the lower rotor 51 facing an inner surface of the lower plate 10 and the upper rotor 52 facing an inner surface of the upper plate 30 are contained in the cartridge case 2 so as to be integrally rotated as shown in FIG. 2B. The shutter plate 51b linked with the lower rotor 51 and the upper rotor 52 revolves together with the lower rotor 51 and the upper rotor 52 to open and close the opening 3. The lower rotor 51 and the upper rotor 52 have ribs (protrusions) 51d and 52d formed around the rotation axis A on facing surfaces of the lower plate 10 and the upper plate 30 so as to rotate with guidance by the lower rotor support groove 18 and the upper rotor support groove 38, respectively, providing smooth closing and open operation.

According to this structure, the lower rotor 10 and the upper rotor 30 rotate in parallel to each other to facilitate providing accuracy, for example, in parallelism to the magnetic disk media 41 arranged between the lower rotor 10 and the upper rotor 30 with high stability in rotation at a high speed range, particularly at a range from 2000 to 8000 rpm.

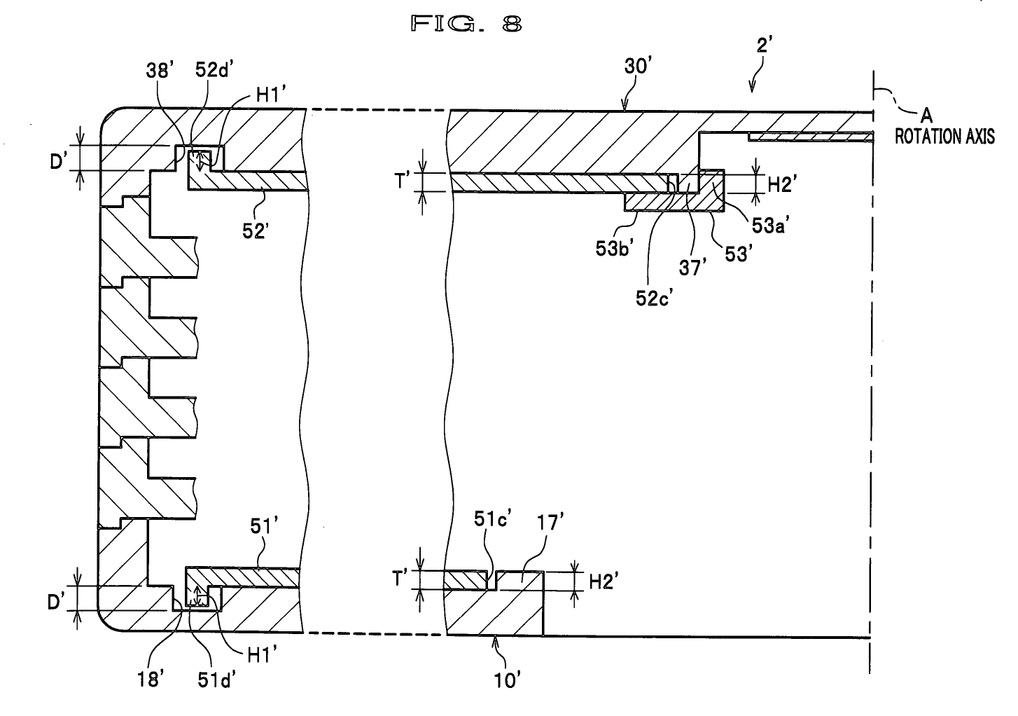

Height H1 of the ribs (protrusions) 51d and 52d of the lower rotor 51 and the upper rotor 52 is, as shown in FIG. 7, greater than depth D of the lower rotor support groove 18 and the upper rotor support groove 38. A distance L between tips of the ribs 51d and 52d of the lower rotor 51 and the upper rotor 52 is smaller than a distance I between bottoms of the lower rotor support groove 18 of the lower plate 10 and the upper rotor support groove 38 of the upper plate 30.

This relation provides gaps S between the lower rotor 51 and the lower plate 10 and between the upper rotor 52 and the upper plate 30, eliminating contact with each other to reduce friction therebetween except the ribs 51d and the 52d. This makes rotation of the lower rotor 51 and the upper rotor 52 smoother as well as the closing and opening operation of the shutter 4.

Similarly, height H2 of the rib (annular rib) 17 and 37 is greater than thickness T of the lower rotor 51 and the upper rotor 52 to provide the gap S, reducing friction and wear therebetween, which makes the rotation of the lower rotor 51 and the upper rotor 52 smoother.

At center portions of the lower rotor 51 and the upper rotor 52 are formed the central openings 51c and 52c, and on the lower plate 10 and the upper plate 30 are formed the ribs 17 and 37 for axially rotatably supporting the central openings 51c and 52c so that the lower rotor 51 and the upper rotor 52 smoothly rotate around the ribs 17 and 37, for example, without axial deflection to provide smooth rotation to the lower rotor 51 and the upper rotor 52.

Further, the stop member 53 fitted in the central opening 52c supports the upper rotor 52, eliminating deflection in the axial direction with smooth rotation of the lower rotor 51 and the upper rotor 52.

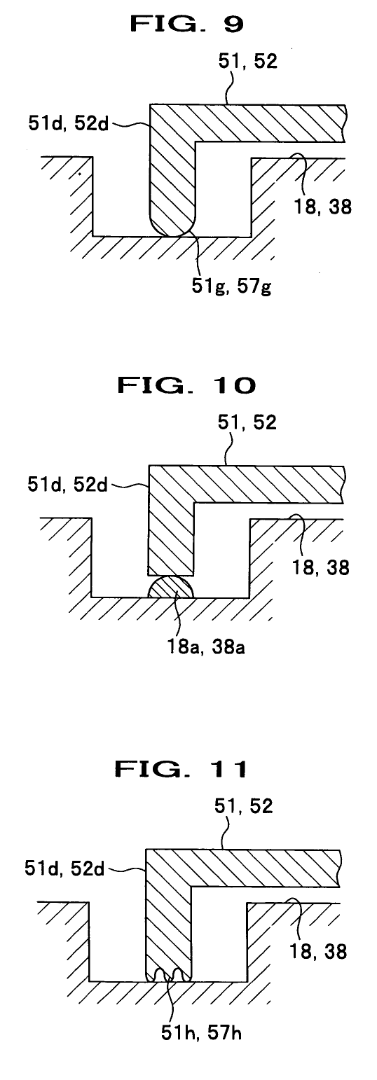

On the other hand, for example, as shown in FIG. 8 illustrating a proto-type of a magnetic disk cartridge, if height H1′ of the ribs (protrusions ) 51d′ and 52d′ of a lower rotor 51′ and an upper rotor 52′ is made smaller than depth D′ of support groove 18′ and 38′ or if height H2′ of ribs (annular ribs) 17′ and 37′ is made smaller than a thickness T′ of the lower rotor 51′ and the upper rotor 52′, there is no gaps S between the lower rotor 51′ and a lower plate 10′ and between the upper rotor 52′ and a lower plate 30′, increasing friction and wear therebetween. This interferes with rotation of the lower rotor 51′ and the upper rotor 52′, so that smooth rotation of the lower rotor 51 and the upper rotor 52 cannot be obtained.

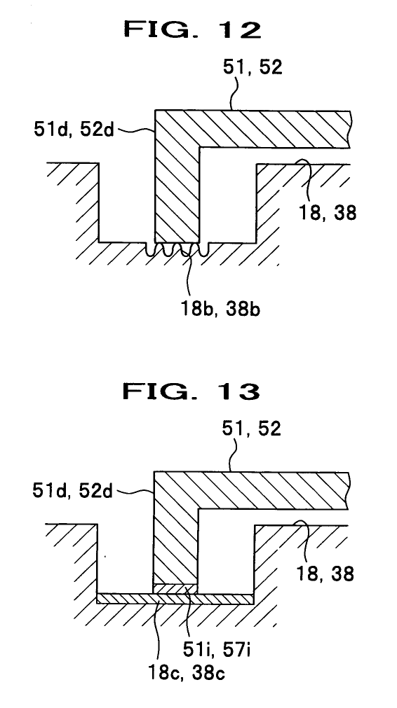

As shown in FIGS. 9 to 13, at least one of a side of the ribs 51d and 52d and a side of the lower rotor support groove 18 and the upper support groove 38 are subjected to a sliding friction reducing process for reducing friction resistance or sliding resistance to improve sliding properties of the ribs 51d and 52d to have smooth closing and opening operation of the shutter 4.

The sliding friction reducing process includes, for example, a surface roughening process (contact surface area reducing process), a friction reducing material arranging process, a lubricant coating process, and an oleoresin forming process.

Thus, a contact surface area reduced portion 51g or 51h is formed at the rib 51d as shown in FIGS. 9 and 11, wherein total contact surface areas at the rib 51d is smaller than the surface areas (contact surface area+non-contact surface area) thereat.

More specifically, the surface roughening process is one for reducing friction resistance or sliding resistance. The rib 51d is made smooth, for example, with a hemispherical surface portion 51g, i.e., curved surface portion 51g as shown in FIG. 9.

Similarly, the contact surface area of the rib 51d can be reduced with the waved surface portion 51h as shown in FIG. 11.

On the other hand, the side of the lower rotor support groove 18 may be subjected to the surface roughing process. The lower rotor support groove 18 may have a hemispherical surface portion 18a as shown in FIG. 10. Further, the lower rotor support groove 18 may have a waved surface portion 18b as shown in FIG. 12.

The rib 52d of the upper rotor 52 may have the same structure. More specifically, the rib 52d is made smooth, for example, with a hemispherical surface portion 57g, i.e., curved surface portion 57g as shown in FIG. 9.

Similarly, the contact surface area of the rib 52d can be reduced with a waved surface portion 57h as shown in FIG. 11.

On the other hand, the side of the upper rotor support groove 38 may be subjected to the surface roughing process. The upper rotor support groove 18 may have a hemispherical surface portion 38a as shown in FIG. 10. Further, the upper rotor support groove 38 may have a waved surface portion 38b as shown in FIG. 12.

In the surface roughening process, for example, if both of the rib 51d and the bottom of the lower rotor support groove 18 have contact surface area reduced portions 51h and 18b on the rib 51d and the bottom of the lower rotor support groove 18, respectively, the waves extending directions of the contact surface area reduced portions 51h and 18b may be perpendicular (not parallel) to each other. This is also applicable to the rib 52d and the bottom of the support rotor support groove 38.

FIG. 13 is a partial sectional view of the rib 51d and the lower rotor support groove 18 or the rib 52d and the upper rotor support groove 38. At least one of the rib 51d and the lower rotor support groove 18 have a friction reduced layer 18c. Similarly, at least one of the rib 52d of the upper rotor 52 and the upper rotor support groove 38 have friction reduced layers 57i and 38c.

The friction reducing material arranging process is a process for providing smooth sliding of the ribs 51d and 52d on the lower rotor support groove 18 and the upper rotor support groove 38, respectively, by arranging thereon a low friction material such as the smoothing member of the above-described center plate 47 as the friction reduced layers 51i and 18c and the friction reduced layers 57i and 38c.

The lubricant coating process is a process for providing smooth sliding between the ribs 51d and 52d and the lower rotor support groove 18 and the upper rotor support groove 38, respectively by coating thereon a low friction material as the friction reduced layers 51i and 18c and the friction reduced layers 57i and 38c.

The oleoresin forming process is a process for providing smooth sliding between the ribs 51d and 52d and the lower support grooves 18 and the upper support groove 38, respectively, with oleoresin as the friction reduced layers 51i and 18c, and the friction reduced layers 57i and 38c to improve their slidable properties.

Further, at least one of the side of ribs 51d and 52d and the side of the lower rotor support groove 18 and the upper rotor support groove 38 is subjected to the wear reducing process. This improves wear resistance of the ribs 51d and 52d to maintain the sliding properties of the lower rotor 51 and the upper rotor 52 preferable.

The wear reducing process includes, for example, the friction reducing material arranging process, the lubricant coating process, and the oleoresin forming process as mentioned above.

The present invention is not limited to the above-described embodiment, but may be modified. For example, the magnetic disk media 41 is used in the above-described embodiment as the recording disk media. However, optical disk media capable of recording using light are adaptive to the present invention.

Further, forms of the ribs (protrusions) 51d and 52b and the support grooves 18 and 38 may be exchanged, namely, the peripherals of the lower rotor 51 and the upper rotor 52 may be formed to have grooves, and the portions at the grooves 18 and 38 may be formed to have protrusions.

The invention claimed is:

1. A recording disk cartridge comprising:
a cartridge case;
a plurality of flexible recording disk media integrally rotatably housed within the cartridge case, the cartridge case comprising:
a lower plate for configuring a lower wall parallel to a plurality of the recording disk media;
an upper plate for configuring an upper wall parallel to a plurality of the recording disk media;
a side wall extending between peripheries of the lower plate and the upper plate and comprising an opening;
a lower rotor arranged inside and facing the lower plate;
an upper rotor arranged inside and facing the upper plate; and
a shutter for closing and opening the opening and providing a linkage between the lower rotor and the upper rotor, wherein the lower rotor and the upper rotor comprise, at the peripheries thereof, arched protrusions with a rotation axis on surfaces thereof facing the lower rotor and the upper rotor, respectively, and the lower plate and the upper plate comprise at peripheries thereof arched grooves with the rotation axis for slidingly fitting in the protrusions, respectively, so as to provide rotational support of the lower rotor and the upper rotor by the lower plate and the upper plate, respectively, with the rotational axis.

2. The recording disk cartridge as claimed in claim 1, further comprising an engage portion engageable with external actuation for operating the shutter to close and open the opening.

3. The recording disk cartridge as claimed in claim 1, further comprising at least one inner plate between the lower rotor and the upper rotor and stacked between the upper plate and the lower plate for partitioning a plurality of the recording disk media.

4. The recording disk cartridge as claimed in claim 1, wherein a height of the protrusions is greater than a depth of the grooves.

5. The recording disk cartridge as claimed in claim 2, wherein a height of the protrusions is greater than a depth of the grooves.

6. The recording disk cartridge as claimed in claim 3, wherein a height of the protrusions is greater than a depth of the grooves.

7. The recording disk cartridge as claimed in claim 4, wherein a distance between the protrusions of the lower rotor and the upper rotor is greater than a distance between the lower plate and the upper plate and smaller than a distance between a bottom of the groove of the lower plate and a bottom of the groove of the upper plate.

8. The recording disk cartridge as claimed in claim 5, wherein a distance between the protrusions of the lower rotor and the upper rotor is greater than a distance between the lower plate and the upper plate and smaller than a distance between a bottom of the groove of the lower plate and a bottom of the groove of the upper plate.

9. The recording disk cartridge as claimed in claim 6, wherein a distance between the protrusions of the lower rotor and the upper rotor is greater than a distance between the lower plate and the upper plate and smaller than a distance between a bottom of the groove of the lower plate and a bottom of the groove of the upper plate.

10. The recording disk cartridge as claimed in claim 1, further comprising a friction reduced portion on at least one of a side of the protrusions and a side of the grooves.

11. The recording disk cartridge as claimed in claim 10, wherein the friction reduced portion comprises a surface area reduced portion.

12. The recording disk cartridge as claimed in claim 10, wherein the friction reduced portion comprises a friction reduced material portion.

13. The recording disk cartridge as claimed in claim 10, wherein the friction reduced portion comprises a lubricant layer.

14. The recording disk cartridge as claimed in claim 10, wherein the friction reduced portion comprises an oleoresin layer.

15. The recording disk cartridge as claimed in claim 1, further comprising a wear reduced portion on at least one of a side of the protrusions and a side of the grooves.

16. The recording disk cartridge as claimed in claim 15, wherein the wear reduced portion comprises a friction reduced material portion.

17. The recording disk cartridge as claimed in claim 15, wherein the wear reduced portion comprises a lubricant layer.

18. The recording disk cartridge as claimed in claim 15, wherein the wear reduced portion comprises an oleoresin layer.

19. The recording disk cartridge as claimed in claim 1, wherein the recording disk media comprise magnetic disk media.

20. A recording disk cartridge comprising:
a cartridge case;
a plurality of flexible recording disk media integrally rotatably housed with a rotation axis within the cartridge case, the cartridge case comprising:
a lower plate for configuring a lower wall parallel to a plurality of the recording disk media;
an upper plate for configuring an upper wall parallel to a plurality of the recording disk media;
a side wall extending between peripheries of the lower plate and the upper plate and comprising an opening;
a lower rotor arranged inside and facing the lower plate;
an upper rotor arranged inside and facing the upper plate; and
a shutter for closing and opening the opening and providing a linkage between the lower rotor and the upper rotor,
wherein the lower rotor and the lower plate comprise, at the peripheries thereof, an arched lower protrusion with the rotation axis and an arched lower groove with the rotation axis for slidingly fitting in the lower protrusion, and the upper rotor and the upper plate comprise, at the peripheries thereof, an arched upper protrusion with the rotation axis and an arched upper groove with the rotation axis for slidingly fitting in the upper protrusion, so as to provide rotational support of the lower rotor and the upper rotor by the lower plate and the upper plate, respectively, with the rotational axis.
